(19) United States
(12) Patent Application Publication
(10) Pub. No.: US 2020/0280713 A1
(43) Pub. Date: Sep. 3, 2020

(54) Imaging Apparatus and Adjustment Method Thereof

(71) Applicant: Hitachi Automotive Systems, Ltd., Hitachinaka-shi, Ibaraki (JP)

(72) Inventor: Koichi SAKITA, Tokyo (JP)

(21) Appl. No.: 16/650,502

(22) PCT Filed: Apr. 16, 2018
(86) PCT No.: PCT/JP2018/015682

§ 371 Date: Mar. 25, 2020

(30) Foreign Application Priority Data
Sep. 26, 2017 (JP) 2017-184248

(51) Int. Cl. H04N 13/246; G01C 3/06; H04N 5/225; H04N 5/217

(52) U.S. Cl. CPC H04N 13/246; H04N 5/2176; H04N 5/2258; G01C 3/06

(57) ABSTRACT

The invention provides an imaging apparatus for minimizing performance degradation due to sensitivity correction while ensuring absolute accuracy of luminance and chromaticity of a subject. An imaging apparatus includes: a sensitivity correction unit which corrects sensitivity characteristics of at least two imaging units to be the same; a storage unit which stores a correction parameter in the sensitivity correction unit; and a luminance calculation unit which calculates a luminance value of a subject on the basis of the correction parameter stored in the storage unit and a shutter value of the imaging unit. Here, the sensitivity correction unit corrects sensitivity characteristics of the at least two imaging units to match the sensitivity characteristic of the imaging unit having the highest sensitivity. Furthermore, the sensitivity correction unit corrects the sensitivity characteristic for each color to be a predetermined ratio and the luminance calculation unit calculates a luminance value for each color of the subject.

### TECHNICAL FIELD

The present invention relates to an imaging apparatus having a plurality of imaging units and an adjustment method thereof and particularly to correction of sensitivity characteristics between the plurality of imaging units.

### BACKGROUND ART

In recent years, an intelligent transport systems (ITS) technology which detects pedestrians and vehicles on a road or in the vicinity thereof using a camera or radar mounted on a vehicle and determines whether they are dangerous for a driver has been developed. Further, in driving support systems such as adaptive cruise control (ACC: constant speed driving and inter-vehicle distance control device) and automatic braking that are presumed to be used on expressways and motorways, a millimeter-wave radar with excellent weather resistance is appropriately used for vehicle detection. However, since it is necessary to detect surrounding road structures, pedestrians, and the like in autonomous driving that requires more advanced functions, a stereo camera capable of obtaining distance information with high spatial resolution is promising.

In the stereo camera, the distance is measured by using the principle of triangulation from a difference in position (parallax) of an object captured by two cameras with different viewpoints on two images, a distance (base line length) between the two cameras, a focal length of the cameras, and the like. The parallax is obtained from the degree of matching in the local region between the left and right images of the two left and right cameras. For this reason, the characteristics of the two cameras need to match as much as possible. If the characteristic difference is large, it is difficult to obtain the parallax.

For this reason, a technology which measures a correction amount such as a gain correction amount or an offset correction amount for each camera in advance during a manufacturing process, stores the correction amount as a look-up table (LUT) in a ROM, and performs correction with reference to the look-up table (LUT) after shipment is disclosed (for example, see Patent Document 1).

### CITATION LIST

### Patent Document

Patent Document 1: JP 5-114099 A

### SUMMARY OF THE INVENTION

### Problems to be Solved by the Invention

In autonomous driving, color information is used to detect traffic signals and road markings. The brightness and color of traffic lights, tail lights, brake lights, and the like are defined by traffic regulations, standards, and the like and are defined by physical quantities such as luminance and chromaticity measured by measuring instruments. When detecting an object using this as a clue, the characteristics of the camera, particularly, the sensitivity characteristics need to match each other between the left and right cameras and need to be the same (absolute accuracy) for all shipped products without depending on individual differences between the left and right cameras. Accordingly, a technology that corrects the sensitivity characteristic becomes important.

Incidentally, in the correction of the sensitivity characteristic, performance degradation such as a decrease in dynamic range or a decrease in maximum saturation output (output gradation) occurs in response to a correction amount. Furthermore, sensitivity characteristics of a color imaging device such as a color CMOS sensor or a color CCD are influenced by not only variations in characteristics of photodiodes but also variations due to semiconductors such as conversion capacitors and amplifier circuits and variations in color filter factors such as color filter thickness distribution and pigment variations. Further, the transmittance of optical filters such as lenses, polarizing filters, and infrared cut filters other than the imaging device also varies. As a result, when the variation in the sensitivity characteristic is widened and the correction is not sufficiently performed, the camera cannot satisfy the required performance.

Further, since the ratio of Red to Green (R/G) and the ratio of Blue to Green (B/G) which are the sensitivity ratio (color balance) of each camera color are set in advance in order to perform detection based on the color determination, correction that satisfies the color balance is necessary.

For such an increasing tendency of the characteristic variation of each camera, in the related art including Patent Document 1 described above, the correction is performed so that the sensitivity characteristics of all camera products to be shipped are made to match the uniform characteristics. As a result, a problem arises in that the manufacturing yield does not increase and the manufacturing cost increases.

An object of the invention is to provide an imaging apparatus for minimizing performance degradation due to sensitivity correction while ensuring absolute accuracy of luminance and chromaticity of a subject and an adjustment method thereof.

### Solutions to Problems

An imaging apparatus of the invention includes: a sensitivity correction unit which corrects sensitivity characteristics of at least two imaging units to be the same; a storage unit which stores a correction parameter in the sensitivity correction unit; and a luminance calculation unit which calculates a luminance value of a subject on the basis of the correction parameter stored in the storage unit and a shutter value of the imaging unit. Here, the sensitivity correction unit corrects sensitivity characteristics of the at least two imaging units to match the sensitivity characteristic of the imaging unit having the highest sensitivity. Furthermore, the sensitivity correction unit corrects the sensitivity characteristic for each color to be a predetermined ratio and the luminance calculation unit calculates a luminance value for each color of the subject.

### Effects of the Invention

According to the invention, it is possible to realize a high-performance imaging apparatus capable of significantly suppressing performance degradation due to sensitivity correction and ensuring absolute accuracy of luminance and chromaticity of a subject and an adjustment method thereof.

### BRIEF DESCRIPTION OF THE DRAWINGS

FIG. 1 is a diagram illustrating an overall configuration of a stereo camera system according to Embodiment 1.

FIG. 2A is a diagram illustrating a sensitivity correction flowchart.

FIG. 2B is a diagram illustrating a luminance value calculation flowchart.

FIG. 3 is a diagram describing a sensitivity correction method and a luminance value calculation method of the embodiment by a graph.

FIG. 4 is a diagram describing performance degradation due to sensitivity correction (Embodiment 2).

FIG. 5A is a diagram describing sensitivity correction between a plurality of cameras (comparative example).

FIG. 5B is a diagram describing sensitivity correction between two cameras.

FIG. 6 is a diagram illustrating a sensitivity correction flowchart of the embodiment.

FIG. 7 is a diagram illustrating an overall configuration of a stereo camera system according to Embodiment 3.

FIG. 8A is a diagram describing sensitivity correction including color balance adjustment (based on G).

FIG. 8B is a diagram describing sensitivity correction including color balance adjustment (based on R).

FIG. 8C is a diagram describing sensitivity correction including color balance adjustment (based on B).

FIG. 9A is a diagram illustrating a sensitivity correction flowchart.

FIG. 9B is diagram illustrating a luminance value calculation flowchart.

### MODE FOR CARRYING OUT THE INVENTION

Hereinafter, embodiments of the invention will be described with reference to the drawings. In the following embodiments, a stereo camera system including two cameras will be described as an example, but the invention can be also applied to a system including two or more cameras.

### Embodiment 1

In Embodiment 1, sensitivity correction performed for each camera in a stereo camera will be described.

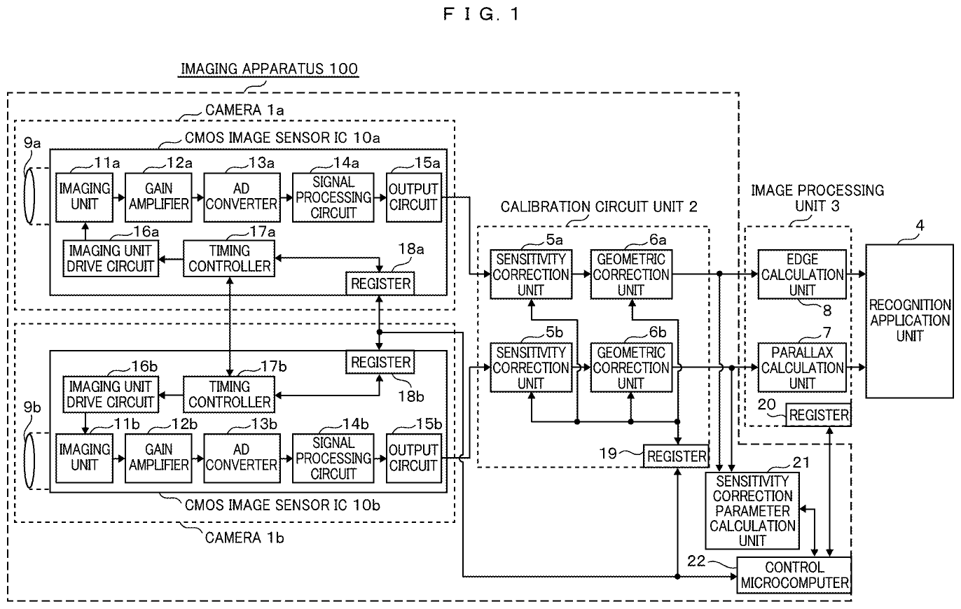

FIG. 1 is a diagram illustrating an overall configuration of a stereo camera system according to Embodiment 1. The stereo camera system includes two left and right cameras 1a and 1b, a calibration circuit unit 2, an image processing unit 3, a recognition application unit 4, a sensitivity correction parameter calculation unit 21, and a control microcomputer 22. Among these, the cameras 1a and 1b, the calibration circuit unit 2, the sensitivity correction parameter calculation unit 21, and the control microcomputer 22 constitute an imaging apparatus 100.

The left and right cameras 1a and 1b are fixed to a casing (not illustrated) so that their optical axes are parallel to each other and two cameras are separated from each other by a predetermined distance. Image data output from the cameras 1a and 1b is corrected by sensitivity correction units 5a and 5b of the calibration circuit unit 2 for the sensitivity variation of the imaging device or the sensitivity variation caused by the transmittance variation of the lens. Further, the geometric correction units 6a and 6b perform geometric correction for lens distortion or the like. Furthermore, a parallax calculation unit 7 of the image processing unit 3 calculates a distance image by stereo matching and generates an edge image by an edge calculation unit 8. The distance image data or the edge image data generated by the image processing unit 3 is transmitted to the recognition application unit 4 to perform image recognition such as person detection, vehicle detection, and signal light detection. Hereinafter, an operation of each component will be described.

The left and right cameras 1a and 1b respectively include lenses 9a and 9b and CMOS image sensor ICs 10a and 10b. The lenses 9a and 9b collect light from a subject and form an image on imaging surfaces of imaging units 11a and 11b of the CMOS image sensor ICs 10a and 10b. In the CMOS image sensor IC, the imaging units 11a and 11b configured as a photodiode array, gain amplifiers 12a and 12b, AD converters 13a and 13b, signal processing circuits 14a and 14b, output circuits 15a and 15b, imaging unit drive circuits 16a and 16b, timing controllers 17a and 17b, and the like are mounted on a semiconductor chip.

Optical signals formed on the imaging surfaces of the imaging units 11a and 11b by the lenses 9a and 9b are converted into analog electric signals, are amplified to a predetermined voltage by the gain amplifiers 12a and 12b, and are converted from analog image signals into digital signals of a predetermined luminance gradation (for example, 1024 gray scales) by the AD converters 13a and 13b. Then, these signals are processed by the signal processing circuits 14a and 14b and are output from the output circuits 15a and 15b.

The settings of the shutter values of the cameras 1a and 1b and the gain amplifiers 12a and 12b are set by the control microcomputer 22 via the registers 18a and 18b. Further, the left and right cameras 1a and 1b are operated in a synchronization manner by the registers 18a and 18b and the timing controllers 17a and 17b.

Correction parameters used in the calibration circuit unit 2 are transmitted from the control microcomputer 22 via a register 19. Correction parameters are registered in the register (the storage unit) 19. The image data corrected by calibration circuit unit 2 is output to the image processing unit 3 and the sensitivity correction parameter calculation unit 21. The control microcomputer 22 has a function of a luminance calculation unit calculating the luminance value on the basis of the image data corrected by the calibration circuit unit 2.

The two left and right image data transmitted to the image processing unit 3 is subjected to matching processing for calculating parallax in the parallax calculation unit 7 and the distance of the object on the image subjected to the matching processing is calculated based on the principle of trigonometry. Here, in order to calculate an accurate distance, highly accurate correction needs to be performed by the calibration circuit unit 2. Accordingly, if the correction is not sufficient, a mismatch will occur and the accurate distance cannot be calculated. Further, the edge calculation is performed on one of the left and right image data by the edge calculation unit 8 and an edge image is output.

The necessary information exchange between the image processing unit 3 and the sensitivity correction parameter calculation unit 21 is performed by the control microcomputer 22 via the register 20. Hereinafter, parameter settings of a sensitivity correction process and an accurate luminance value calculation process using the sensitivity correction parameter calculation unit 21 will be described.

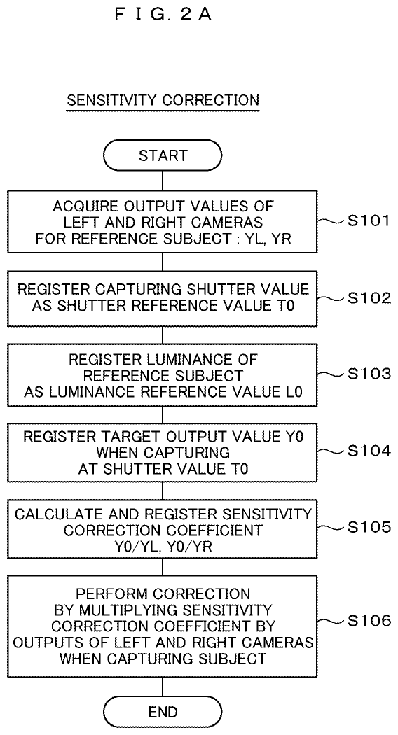

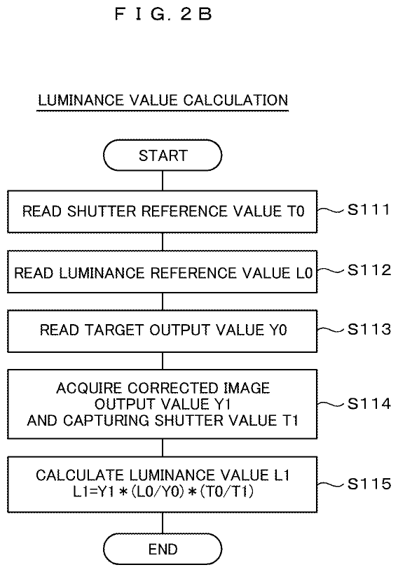

FIGS. 2A and 2B are diagrams illustrating a sensitivity correction flowchart and a luminance value calculation flowchart. First, FIG. 2A illustrates a sensitivity correction routine. In this routine, sensitivity correction is performed for the left and right cameras 1a and 1b using a reference subject (for example, a halogen light source having a constant spectral characteristic) fixed to a known position and having a constant spectral characteristic at all times. The sensitivity correction can be also performed by car dealers using a predetermined light source in addition to the correction during the manufacturing process. Also, if the luminance can be guaranteed by incorporating an LED light source into an emblem on an electric display panel or a hood that provides accurate luminance, the invention can be implemented even during traveling. The image data necessary for calculation is taken and calculated by the sensitivity correction parameter calculation unit 21. A series of operations are controlled by the control microcomputer 22. The processing contents will be described in order of steps.

In S101, a reference subject is captured by the left and right cameras 1a and 1b to acquire an output value of a specific pixel in the captured image data. These values are indicated by YL and YR. The output values YL and YR may be average values of a plurality of pixels in the captured image data. Further, the information from the image processing unit 3 may be used to select a specific pixel region in the image data and a calculation may be performed from that region.

In S102, a capturing shutter value is registered as a shutter reference value T0 in the register 19. In S103, a luminance value of the reference subject is registered as a luminance reference value L0 in the register 19. In this routine, the luminance of the subject is known because a specific subject serving as a reference such as a halogen light source is used as a reference subject.

In S104, when the reference subject of the luminance value L0 is captured with a shutter value T0, a value to be output is registered as a target output value Y0 in the register 19. In S105, sensitivity correction coefficients (Y0/YL) and (Y0/YR) for changing the output values YL and YR of the left and right cameras 1a and 1b to the target output value Y0 are calculated and registered in the register 19.

In S106, at the time of capturing an actual subject, the sensitivity correction units 5a and 5b multiply the sensitivity correction coefficients (Y0/YL) and (Y0/YR) registered in the register 19 by the output obtained from the cameras 1a and 1b and output image data subjected to sensitivity correction.

FIG. 2B illustrates a luminance value calculation routine. In this routine, an accurate luminance value used to detect an object is calculated from the corrected output image data by the control microcomputer (the luminance calculation unit) 22.

In S111, the shutter reference value T0 registered in the register 19 in S102 described above is read. In S112, the luminance reference value L0 registered in the register 19 in S103 described above is read. In S113, the target output value Y0 registered in the register 19 in S104 described above is read.

In S114, a corrected image output value distribution Y1(i, j) and a capturing shutter value T1 are acquired. In S115, an image luminance distribution L1(i, j) is calculated by the following formula using parameters L0, Y0, T0, and T1.

L1(i,j)=Y1(i,j)*(L0/Y0)*(T0/T1)

Accordingly, the luminance of the subject can be obtained with high accuracy.

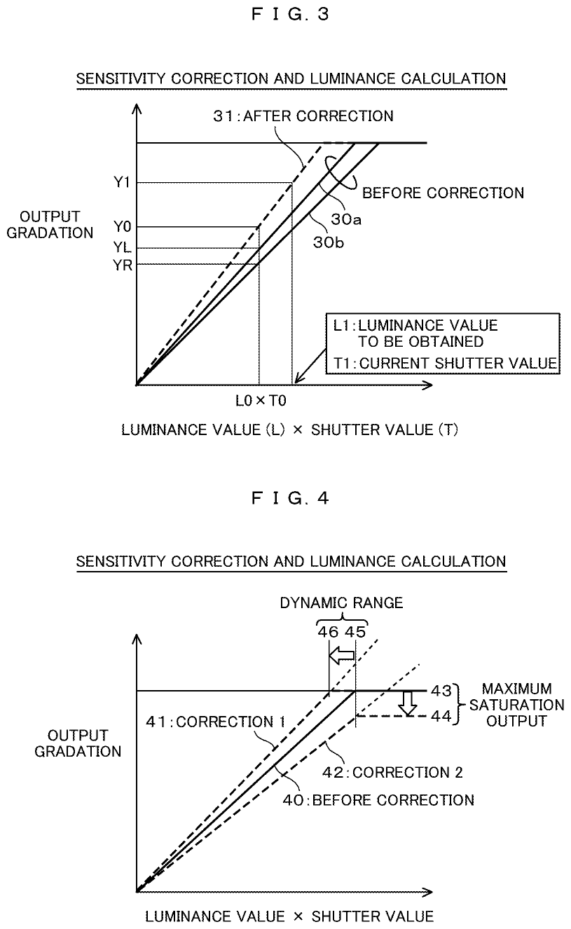

FIG. 3 is a diagram describing a sensitivity correction method and a luminance value calculation method of the embodiment by a graph. The vertical axis indicates the output gradation (output value) Y of the camera and the horizontal axis indicates the product of the luminance value L of the subject and the shutter value T. The horizontal axis indicates the total amount of light from the subject and the slope of the graph indicates the sensitivity characteristics of the camera. For example, the sensitivity characteristics of the cameras 1a and 1b are indicated by solid lines 30a and 30b. In the sensitivity correction, correction is performed so that the output values YL and YR when the reference subject of the luminance value L0 is captured by the shutter value T0 become the target output value Y0. The corrected sensitivity characteristic is indicated by a dashed line 31.

The slope k=Y0/(L0*T0) of the linear portion of the corrected sensitivity characteristic 31 indicates the corrected sensitivity. By using this relationship, the luminance value when the output gradation is Y1 when an arbitrary subject is captured with the shutter value T1 is obtained by L1=Y1/(k*T1). That is, when the target output value Y0 at the shutter reference value T0 and the luminance reference value L0 is registered, an accurate luminance value L1 can be calculated from the output value Y1 of the subject having arbitrary luminance.

In this way, according to Embodiment 1, the sensitivity of each of the left and right cameras of the stereo camera is corrected and the corrected camera output value can be converted into an accurate luminance value by a common luminance calculation formula using parameters T0, L0, and Y0. In that case, the parameters T0, L0, and Y0 may be set and registered for each pair of left and right cameras. Accordingly, absolute accuracy can be ensured for the luminance value of the subject to be calculated.

### Embodiment 2

In Embodiment 2, sensitivity correction between the left and right cameras of the stereo camera will be described. Although the dynamic range and the maximum saturation output are reduced due to the sensitivity correction, in the embodiment, these performance degradations are minimized.

FIG. 4 is a diagram describing performance degradation due to sensitivity correction. The horizontal axis indicates the product of the luminance value of the subject and the shutter value and indicates the total amount of the light from the subject. The vertical axis indicates the output gradation of the camera and the slope of the graph indicates the sensitivity characteristic of the camera. Here, the non-corrected sensitivity characteristic of one camera is indicated by a solid line 40. As a correction method, the target characteristic in the case (correction 1) of correcting to the higher sensitivity is indicated by a dashed line 41 and the target characteristic in the case (correction 2) of correcting to the lower sensitivity is indicated by a dashed line 42. Hereinafter, these will be compared.

First, in the case (correction 1) of correcting to the higher sensitivity, since the maximum saturation output 43 of the non-corrected characteristic is determined (as the maximum gradation value of the AD converters 13a and 13b), the dynamic range which is the range in which the brightness can be identified by the camera decreases from a position of a reference numeral 45 to a position of a reference numeral 46. A decrease amount of the dynamic range depends on the correction amount. Since the non-corrected camera characteristics vary, the cameras having different dynamic ranges coexist with the sensitivity correction.

Meanwhile, in the case (correction 2) of correcting to the lower sensitivity, since the maximum saturation output 43 of the non-corrected characteristic is determined, the maximum saturation output of the corrected characteristic decreases to a level of a reference numeral 44. A decrease in maximum saturation output depends on the correction amount. Since the non-corrected camera characteristics vary, the cameras having different maximum saturation outputs coexist with the sensitivity correction.

In this way, the dynamic range or the maximum saturation output decreases due to sensitivity correction. From a practical viewpoint, when a stereo matching process is performed by the left and right cameras, if the saturation outputs of the left and right cameras are different, the matching process near the saturation point cannot be performed normally. As a result, since the image processing unit 3 cannot calculate an accurate distance to the subject, the camera is not suitable as a stereo camera for automatic driving. Thus, a method (correction 1) of correcting to the higher sensitivity is selected by giving priority to suppressing a decrease in the maximum saturation output over a decrease in the dynamic range caused by the sensitivity correction. Hereinafter, a method (correction 1) of correcting to the higher sensitivity will be described.

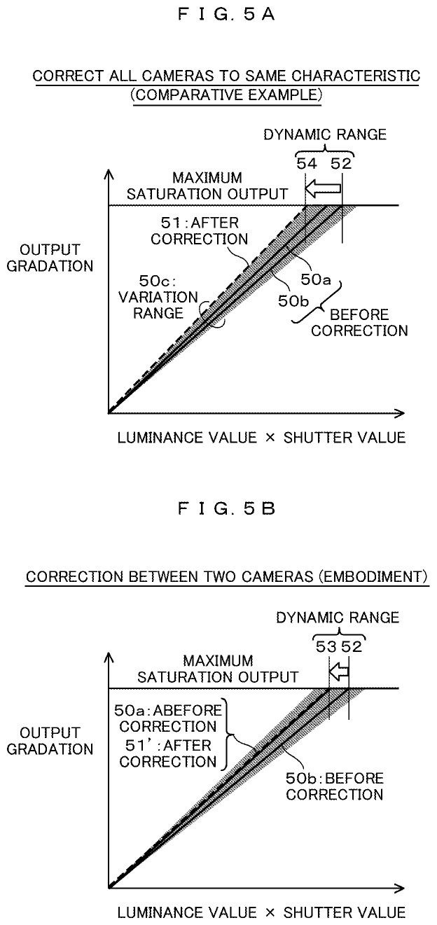

FIGS. 5A and 5B are diagrams describing sensitivity correction between a plurality of cameras and illustrate a sensitivity correction method of minimizing performance degradation. Also, non-corrected sensitivity characteristics 50a and 50b of the left and right cameras 1a and 1b used as the stereo camera and a sensitivity variation range 50c of all cameras are illustrated. Here, the non-corrected sensitivity 50a of the camera 1a is set to be higher than the non-corrected sensitivity 50b of the camera 1b.

FIG. 5A illustrates a case (a comparative example) when the characteristics of all cameras are corrected to the same characteristic. A corrected target characteristic 51 is set to the maximum sensitivity characteristic in a sensitivity variation range 50c. In order to match the target characteristic 51, a decrease amount of the dynamic range of the camera greatly increases. For example, the dynamic range of the non-corrected sensitivity 50b (the camera 1b) decreases from a position of a reference numeral 52 to a position of a reference numeral 54.

FIG. 5B illustrates a case (embodiment) in which the sensitivity is corrected to the higher sensitivity in the left and right cameras 1a and 1b. In this example, since the sensitivity 50a of the camera 1a is high, a corrected target characteristic 51′ is set to the sensitivity 50a. Thus, the sensitivity 50b of the camera 1b may match the sensitivity 50a of the camera 1a. In this case, the correction amount only needs to be a difference in the sensitivity between the left and right cameras 1a and 1b forming a pair. When the dynamic range of the non-corrected sensitivity 50b (the camera 1b) only decreases from a position of the reference numeral 52 to a position of a reference numeral 53, a decrease in the dynamic range can be suppressed to a minimum.

Additionally, a method of registering parameters used in the luminance value calculation is different due to a difference in sensitivity correction. In the case of FIG. 5A, the shutter reference value T0, the luminance reference value L0, and the target output value Y0 are registered as the same values in all cameras. On the other hand, in the case of FIG. 5B, the shutter reference value T0 and the luminance reference value L0 are registered with the same value for all cameras and the target output value Y0 is registered individually for each camera in the pair.

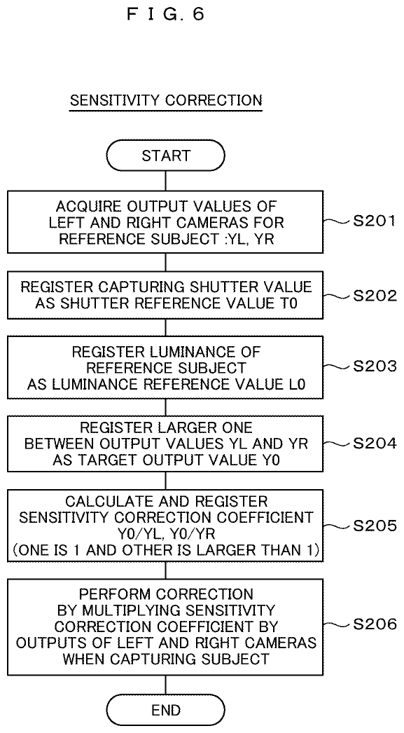

FIG. 6 is a diagram illustrating a sensitivity correction flowchart of the embodiment. As illustrated in FIG. 5B, the left and right cameras 1a and 1b correct the characteristics with higher sensitivity.

In S201 to S203, the output values YL and YR of the specific pixels in the captured image data of the reference subject are acquired, the capturing shutter value is set to the shutter reference value T0, and the luminance of the reference subject is registered as the luminance reference value L0 in the register 19. These are the same as those of S101 to S103 of FIG. 2A.

In S204, the large one of the output values YL and YR of the left and right cameras is registered as the target output value Y0 in the register 19. The target output value Y0 is registered as an individual value for each camera in the pair.

In S205, the sensitivity correction coefficients (Y0/YL) and (Y0/YR) for setting the output values YL and YR of the left and right cameras 1a and 1b to the target output value Y0 are calculated and registered in the register 19. Since any one of the output values YL and YR is the same as Y0, the correction coefficient is 1 and the other correction coefficient is a value larger than 1 (correction of increasing the sensitivity).

In S206, when capturing an actual subject, the sensitivity correction units 5a and 5b multiply the sensitivity correction coefficients (Y0/YL) and (Y0/YR) registered in the register 19 by the output from the cameras 1a and 1b and output the image data subjected to the sensitivity correction.

The routine of the luminance value calculation is the same as that of FIG. 2B and a description thereof is omitted. However, the value of the target output value Y0 read in S113 is different in that the value is individually registered for each camera.

According to Embodiment 2, since the sensitivities of the left and right cameras of the stereo camera are corrected to match the higher sensitivity, a decrease in the dynamic range due to the sensitivity correction can be suppressed to a minimum.

### Embodiment 3

In Embodiment 3, the case of further adjusting a color balance in the sensitivity correction between the left and right cameras of the stereo camera will be described.

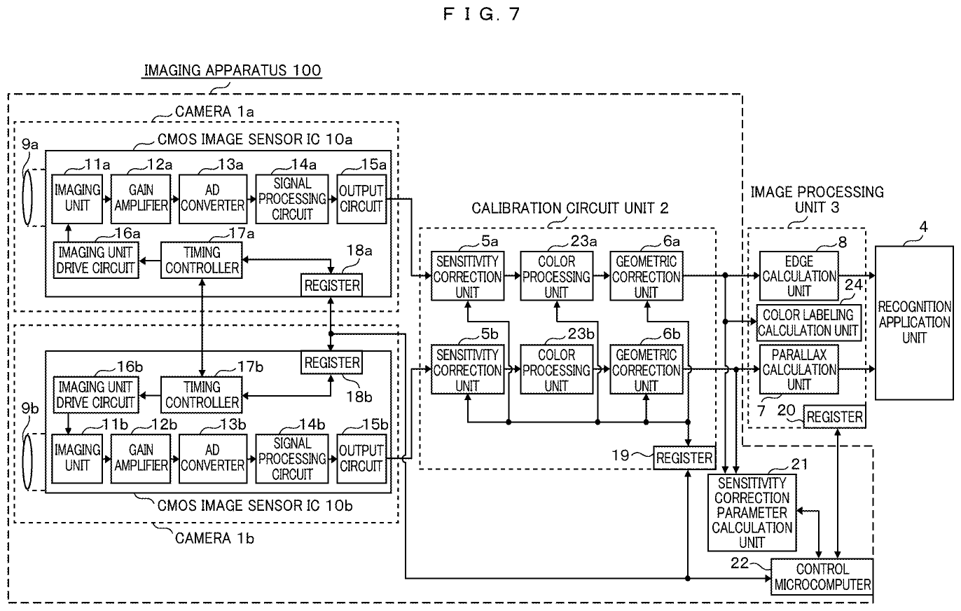

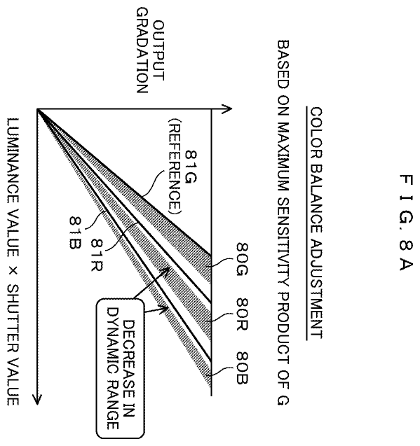

FIG. 7 is a diagram illustrating an overall configuration of a stereo camera system according to Embodiment 3. The same reference numerals will be given to the same components as those of Embodiment 1 (FIG. 1) and a description thereof will be omitted. In the configuration of FIG. 1, a color image sensor is used for the imaging units 11a and 11b. Further, color processing units 23a and 23b are added to the calibration circuit unit 2 and a color labeling calculation unit 24 is added to the image processing unit 3.

For the color image data output from the left and right cameras 1a and 1b, the sensitivity correction units 5a and 5b of the calibration circuit unit 2 perform sensitivity correction on each color data of Red (R), Green (G), and Blue (B). In the output of a color image, the ratio of each color output of the camera when capturing a predetermined light source, that is, the color balance is determined to be a predetermined value. Specifically, the sensitivity correction is performed so that the ratio of Red and Green (R/G) and the ratio of Blue and Green (B/G) become predetermined values. In the color processing units 23a and 23b, a process such as demosaicing (a complementary process using adjacent pixel values) is performed on the imaging device having a Bayer array.

The parallax calculation unit 7 calculates the parallax of two left and right image data transmitted to the image processing unit 3 and the edge calculation unit 8 performs edge calculation on one of the left or right image data. Furthermore, in the color labeling calculation unit 24, each coordinate position is assigned to a numerical value labeled in the color space.

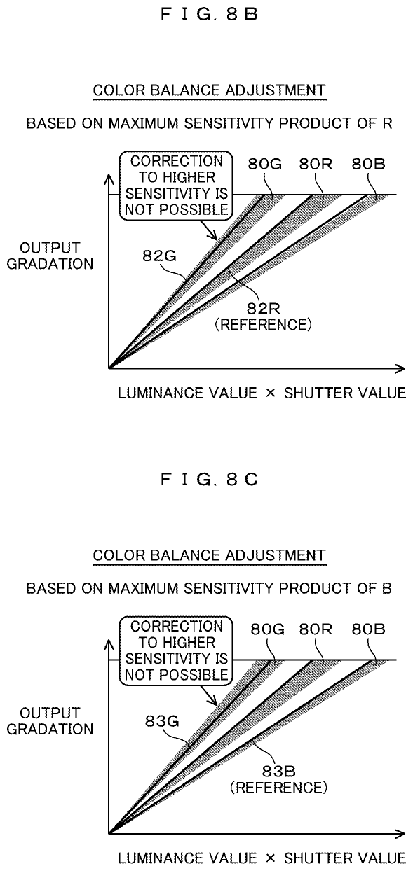

FIGS. 8A to 8C are diagrams describing sensitivity correction including color balance adjustment. Assuming that the sensitivity of the camera is corrected to the characteristic having the highest sensitivity, the color balance is further performed. At this time, it illustrates a case in which the performance degradation due to the sensitivity correction is further increased or a case in which the sensitivity correction cannot be performed. This case to be determined depends on the sensitivity variation of each color of Red (R), Green (G), and Blue (B) and the value of the desired color balance R/G and B/G. In FIGS. 8A to 8C, it is assumed that the sensitivity variation ranges of the respective colors (R, G, B) are respectively in the states indicated by reference numerals 80R, 80G, and 80B.

FIG. 8A illustrates a case in which the color balance is adjusted based on the maximum sensitivity product of Green (G). That is, the target sensitivity characteristic 81G of G is set to the maximum sensitivity of the sensitivity variation range 80G of G. On the other hand, in order to adjust the color balance, the target sensitivity characteristics 81R and 81B of R and B are obtained by multiplying the target sensitivity characteristic 81G of G by predetermined color balance values (R/G, B/G). At this time, when the maximum sensitivity product of R and B (the maximum sensitivities of the sensitivity variation ranges 80R and 80B) is smaller than the target sensitivity characteristics 81R and 81B of R and B, the sensitivity correction of R and B exceeds the variation width. That is, a decrease in the dynamic range increases.

Meanwhile, FIG. 8B illustrates a case in which the color balance is adjusted based on the maximum sensitivity product of Red (R). That is, the target sensitivity characteristic 82R of R is set to the maximum sensitivity of the sensitivity variation range 80G of R. On the other hand, when the color balance is adjusted, the target sensitivity characteristic 82G of G is included in the sensitivity variation range 80G of G. At that time, a camera having a sensitivity higher than the target sensitivity characteristic 82G of G cannot be corrected to a higher sensitivity. Thus, since the sensitivity cannot be corrected to the lower sensitivity, the maximum saturation output decreases as illustrated in FIG. 4.

FIG. 8C illustrates a case in which the color balance is adjusted based on the maximum sensitivity product of Blue (B). Also in this case, the target sensitivity characteristic 83G of G is included in the sensitivity variation range 80G of G by the color balance adjustment, but in the camera of which the sensitivity is larger than the target sensitivity characteristic 83G of G, the sensitivity cannot be corrected to the higher sensitivity. Thus, since the sensitivity is corrected to the lower sensitivity, the maximum saturation output decreases.

In this way, when the sensitivity correction including the color balance adjustment is performed, there are several cases in which the dynamic range further decreases or the maximum saturation output decreases for the color other than the reference color during adjustment. As described above, since it is advantageous to suppress a decrease in the maximum saturation output from the practical viewpoint, it is necessary to avoid a case in which the sensitivity cannot be corrected to the higher sensitivity as in FIG. 8B or 8C. That is, as in FIG. 8A, a method of correcting the sensitivity to the higher sensitivity for any color is adopted. Hereinafter, such sensitivity correction will be referred to as “minimum correction” which means that the correction amount is minimized. In order to realize the minimum correction, it is necessary to determine the reference color of the sensitivity correction depending on the sensitivity variation situation of R, G, and B. Next, a correction method which realizes the color balance and the minimum correction will be described.

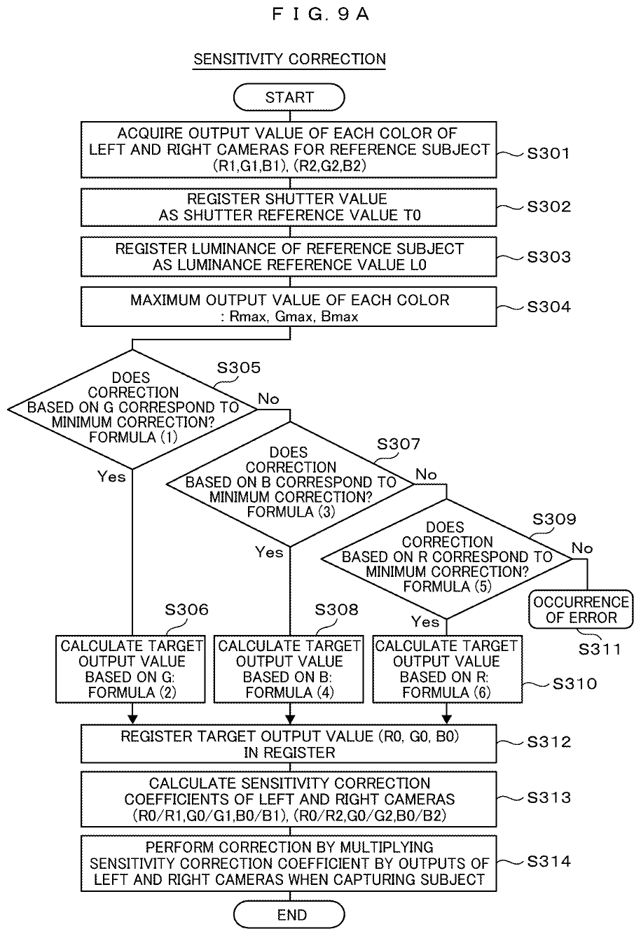

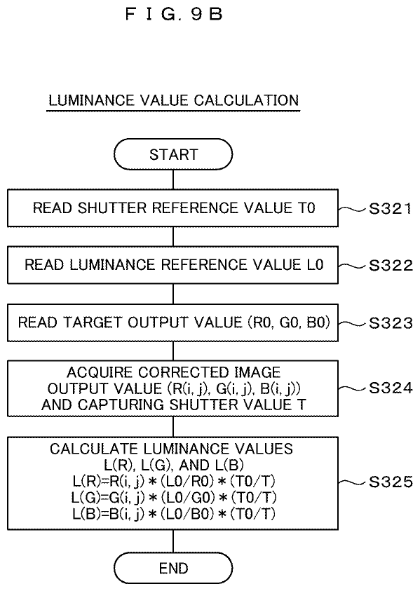

FIGS. 9A and 9B are diagrams illustrating a sensitivity correction flowchart and a luminance value calculation flowchart of the embodiment. In addition, the color balance value is determined in advance so as to realize R/G=α and B/G=β.

First, FIG. 9A illustrates a sensitivity correction routine. In S301, the output value for each of RGB colors of a specific pixel in the captured image data of the reference subject is acquired by the left and right cameras 1a and 1b. These values are (R1, G1, B1) and (R2, G2, B2). As the output value, a plurality of pixels in the captured image data may be averaged for each color. Further, a specific pixel region in the image data may be selected by the information from the image processing unit 3 and may be calculated for each color from that region.

In S302, the capturing shutter value is registered as the shutter reference value T0 in the register 19. In S303, the luminance value of the reference subject is registered as the luminance reference value L0 in the register 19. In S304, the output values of each color of the left and right cameras are compared and the larger value is set as (Rmax, Gmax, Bmax).

In S305 to S311, the color to be used for the color balance is determined. The determination formula used here is a condition for realizing correction (minimum correction) of a color other than the reference color to a higher sensitivity as illustrated in FIG. 8A.

In S305, it is determined whether the correction of R and B based on Gmax is the minimum correction by Formula (1). When Formula (1) is satisfied, the routine proceeds to S306. Meanwhile, when the formula is not satisfied, the routine proceeds to S307. In S306, the target output value (R0, G0, B0) is calculated by Formula (2).

Rmax/Gmax<α and Bmax/Gmax<β (1)

R0=α*Gmax,G0=Gmax, and B0=β*Gmax (2)

In S307, it is determined whether the correction of R and G based on Bmax is the minimum correction by Formula (3). When Formula (3) is satisfied, the routine proceeds to S308. Meanwhile, when the formula is not satisfied, the routine proceeds to S309. In S308, the target output value (R0, G0, B0) is calculated by Formula (4).

Rmax/Bmax<α/β and Gmax/Bmax<1/β (3)

R0=(α/β)Bmax,G0=(1/β)Bmax, and B0=Bmax (4)

In S309, it is determined whether the correction of B and G based on Rmax is the minimum correction by Formula (5). When Formula (5) is satisfied, the routine proceeds to S310. Meanwhile, when the formula is not satisfied, the process ends such that an error occurs in S311. In S310, the target output value (R0, G0, B0) is calculated by Formula (6).

Gmax/Rmax<1/α and Bmax/Rmax<β/α (5)

R0=Rmax,G0=(1/α)Rmax, and B0=(β/α)Rmax (6)

In S312, the calculated target output value (R0, G0, B0) is registered in the register. In S313, the sensitivity correction coefficients (R0/R1, G0/G1, B0/B1) and (R0/R2, G0/G2, B0/B2) for setting the output values (R1, G1, B1) and (R2, G2, B2) of the left and right cameras 1a and 1b as the target output value (R0, G0, B0) are calculated and registered in the register 19.

In S314, when capturing an actual subject, the sensitivity correction units 5a and 5b multiply the sensitivity correction coefficients (R0/R1, G0/G1, B0/B1) and (R0/R2, G0/G2, B0/B2) registered in the register 19 by the output from the cameras 1a and 1b and output the image data subjected to the sensitivity correction.

FIG. 9B illustrates a luminance value calculation routine. In S321, the shutter reference value T0 registered in the register 19 in S302 described above is read. In S322, the luminance reference value L0 registered in the register 19 in S303 described above is read. In S323, the target output value (R0, G0, B0) registered in the register 19 in S312 described above is read.

In S324, the corrected image output value (R(i, j), G(i, j), B(i, j)) and the capturing shutter value T are acquired. In S325, an accurate luminance distribution L(R), L(G), and L(B) for R, G, and B is calculated by the following formula using the parameters L0, R0, G0, B0, T0, and T. From these, the chromaticity value can be obtained.

L(R)=R(i,j)*(L0/R0)*(T0/T)

L(G)=G(i,j)*(L0/G0)*(T0/T)

L(B)=B(i,j)*(L0/B0)*(T0/T)

From above, it is possible to correct the sensitivity characteristics of the left and right cameras to the higher sensitivity for any color while keeping the color balance of R, G, and B to a predetermined value and to calculate the chromaticity value along with the accurate luminance distribution of the subject.

According to Embodiment 3, it is possible to suppress a decrease in the dynamic range due to the sensitivity correction to a minimum while keeping the color balance at a predetermined value in the sensitivity correction of the left and right cameras of the stereo camera. Further, it is possible to ensure an absolute accuracy for the luminance value (the chromaticity value) of each color of the subject to be calculated.

According to the above-described embodiments, since only the correction of the sensitivity variation between the two units in the pair is performed even when there is a large variation in the sensitivity of the imaging device used in the stereo camera to be manufactured, performance degradation such as a decrease in dynamic range due to sensitivity correction can be greatly suppressed. Further, since the corrected sensitivity characteristic unique to each stereo camera serial number is stored and the luminance value is calculated from the stored sensitivity characteristic and the shutter value, the luminance value of the subject can be measured while ensuring absolute accuracy without depending on individual differences between the stereo camera serial numbers.

In the above-described embodiments, the stereo camera system including two cameras has been described as an example, but the invention is not limited thereto. The invention can be also applied to a multi-eye camera or a multi-view camera using two or more cameras.

### REFERENCE SIGNS LIST

1a, 1b Camera
2 Calibration circuit unit
3 Image processing unit
4 Recognition application unit
5a, 5b Sensitivity correction unit
6a, 6b Geometric correction unit
7 Parallax calculation unit
8 Edge calculation unit
11a, 11b Imaging unit
13a, 13b AD converter
19, 20 Register (storage unit)
21 Sensitivity correction parameter calculation unit
22 Control microcomputer (luminance calculation unit)
23a, 23b Color processing unit
24 Color labeling calculation unit
100 Imaging apparatus

1. An imaging apparatus for capturing a subject by pairing a plurality of imaging units, comprising:
a sensitivity correction unit which corrects sensitivity characteristics of at least two imaging units to be the same;
a storage unit which stores a correction parameter in the sensitivity correction unit; and
a luminance calculation unit which calculates a luminance value of the subject on the basis of the correction parameter stored in the storage unit and a shutter value of the imaging unit.

2. The imaging apparatus according to claim 1,
wherein the sensitivity correction unit corrects sensitivity characteristics of the at least two imaging units to match the sensitivity characteristic of the imaging unit having the highest sensitivity.

3. The imaging apparatus according to claim 1,
wherein the sensitivity correction unit further performs corrections so that the sensitivity characteristic for each color becomes a predetermined ratio and the luminance calculation unit calculates a luminance value for each color of the subject.

4. The imaging apparatus according to claim 3,
wherein the sensitivity correction unit corrects the sensitivity characteristic of one color (hereinafter, referred to as a reference color) of colors of the at least two imaging units to match the sensitivity characteristic of the imaging unit having the highest sensitivity of the reference color and corrects the sensitivity characteristics of all colors other than the reference color to have higher sensitivity.

5. A method of adjusting an imaging apparatus for capturing a subject by pairing a plurality of imaging units, comprising:
a sensitivity correction step of correcting sensitivity characteristics of at least two imaging units to be the same;
a parameter calculation step of calculating a correction parameter in the sensitivity correction step; and
a luminance calculation step of calculating a luminance value of the subject on the basis of the correction parameter and a shutter value of the imaging unit.

6. The imaging apparatus adjustment method according to claim 5,
wherein in the sensitivity correction step, the sensitivity characteristics of at least two imaging units are corrected to be the same as the sensitivity characteristic of the imaging unit having the highest sensitivity.

7. The imaging apparatus adjustment method according to claim 5,
wherein in the sensitivity correction step, the sensitivity characteristic for each color is further corrected to be a predetermined ratio, and
wherein in the luminance calculation step, a luminance value for each color of the subject is calculated.

8. The imaging apparatus adjustment method according to claim 7,
wherein in the sensitivity correction step, the sensitivity characteristic of one color (hereinafter, referred to as a reference color) of colors of the at least two imaging units is corrected to match the sensitivity characteristic of the imaging unit having the highest sensitivity of the reference color and the sensitivity characteristics of all colors other than the reference color are corrected to have higher sensitivity.
